(19) United States
(12) Patent Application Publication
(10) Pub. No.: US 2023/0008310 A1
(43) Pub. Date: Jan. 12, 2023

(54) COMMUNICATION DEVICE, NON-TRANSITORY COMPUTER-READABLE RECORDING MEDIUM STORING COMPUTER-READABLE INSTRUCTIONS FOR COMMUNICATION DEVICE, NON-TRANSITORY COMPUTER-READABLE RECORDING MEDIUM STORING COMPUTER-READABLE INSTRUCTIONS FOR SERVER, AND SERVER

(71) Applicant: BROTHER KOGYO KABUSHIKI KAISHA, Nagoya (JP)

(72) Inventor: Kentaro ARAI, Nagoya (JP)

(21) Appl. No.: 17/810,951

(22) Filed: Jul. 6, 2022

(30) Foreign Application Priority Data
Jul. 8, 2021 (JP) 2021-113790

(51) Int. Cl. H04L 9/40

(52) U.S. Cl. CPC H04L 63/083; H04L 63/0876; H04L 63/107

(57) ABSTRACT

A communication device may: send a change instruction including identification information to a server, wherein the server may store the identification information and target user information corresponding to a user of a terminal device in association with each other, and the change instruction may be a signal to instruct the server to send first authentication information to the terminal device by using the target user information, after the first authentication information has been sent from the server to the terminal device, accept input of the first authentication information, in a case where the input of the first authentication information is accepted, send the first authentication information to the server, in a case where the first authentication information is sent to the server, receive a change permission notification from the server, and in a case where the change permission notification is received from the server, change the password.

### REFERENCE TO RELATED APPLICATIONS

This application claims priority from Japanese Patent Application No. 2021-113790 filed on Jul. 8, 2021. The entire contents of the priority application is incorporated herein by reference.

### BACKGROUND ART

A technology for changing a security code for using a Multi-Function Peripheral (MFP) is known. In this technology, the MFP executes a process for changing the security code when accepting input of a wrong security code from a user.

### DESCRIPTION

The disclosure herein provides a technology for securely changing a password of a communication device.

A communication device disclosed herein may comprise a controller. The controller may be configured to: accept a predetermined instruction for changing a password of the communication device from a user; in a case where the predetermined instruction is accepted, send a change instruction including identification information for identifying the communication device to a server, wherein the server stores the identification information and target user information corresponding to the user of a terminal device different from the communication device in association with each other, and the change instruction is a signal to instruct the server to send first authentication information to the terminal device by using the target user information stored in association with the identification information included in the change instruction; after the first authentication information has been sent from the server to the terminal device, accept input of the first authentication information from the user; in a case where the input of the first authentication information is accepted, send the first authentication information to the server; in a case where the first authentication information is sent to the server, receive a change permission notification from the server; and in a case where the change permission notification is received from the server, change the password of the communication device.

According to the configuration above, the communication device sends the change instruction to the server when accepting the predetermined instruction. As a result, the first authentication information is sent from the server to the terminal device and the first authentication information is inputted to the communication device by the user of the terminal device. In this case, the communication device sends the first authentication information to the server and receives the change permission notification from the server. As a result, the communication device changes its password. Thus, the password of the communication device can be changed securely.

Also, a non-transitory computer-readable recording medium storing computer-readable instructions for a server is disclosed herein. The server may comprise a memory configured to store identification information for identifying a communication device and target user information corresponding to a user of a terminal device different from the communication device in association with each other; and a processor. The computer-readable instructions, when executed by the processor, may cause the server to: receive a change instruction including the identification information from the communication device; in a case where the change instruction is received from the communication device, send first authentication information to the terminal device by using the target user information stored in association with the identification information included in the change instruction, wherein the first authentication information is inputted to the communication device by the user of the terminal device after the first authentication information has been sent to the terminal device; in a case where the first authentication information is inputted to the communication device, receive the first authentication information from the communication device; and in a case where the first authentication information is received from the communication device, send a change permission notification to the communication device, wherein the change permission notification is a notification to permit the communication device to change a password of the communication device.

According to the configuration above, the server sends the first authentication information to the terminal device when receiving the change instruction from the communication device. Thereafter, when the first authentication information is inputted to the communication device by the user of the terminal device, the server receives the first authentication information from the communication device and sends the change permission notification to the communication device. As a result, changing the password is permitted at the communication device. Thus, the password of the communication device can be changed securely.

Computer readable instructions for the communication device, a computer-readable recording medium storing the computer-readable instructions, and a method executed by the communication device are also novel and useful. Further, the computer-readable instructions as above, the server, and a method executed by the server are also novel and useful. Further, a communication system comprising the server, the communication device, and the terminal device is also novel and useful.

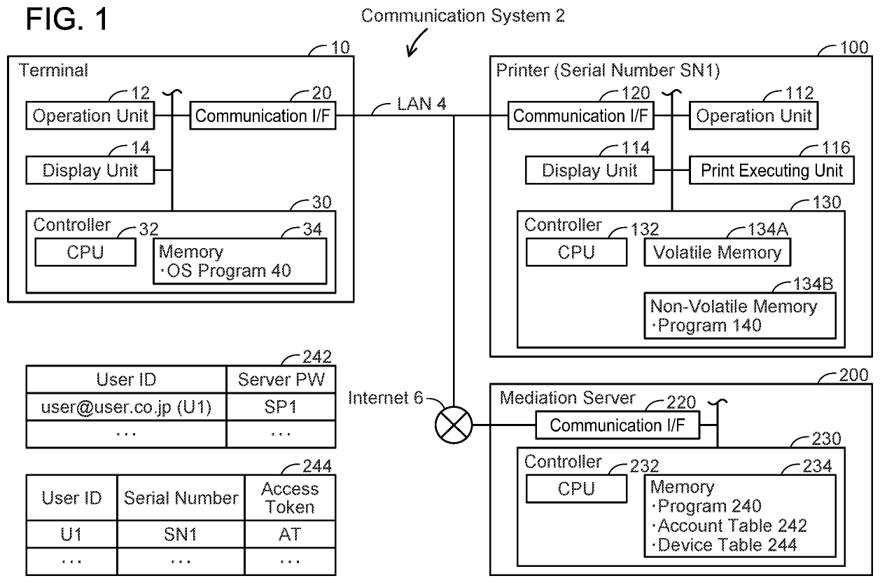

FIG. 1 illustrates a configuration of a communication system;

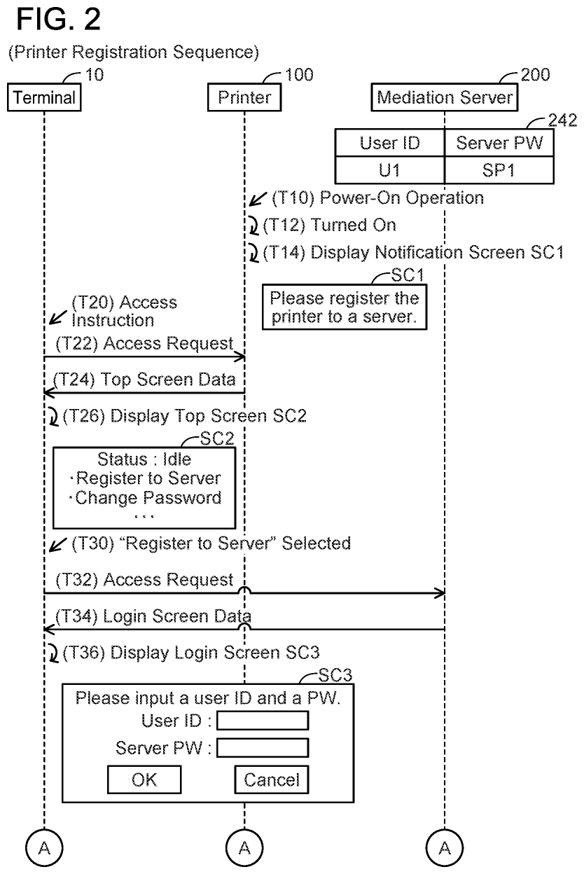

FIG. 2 illustrates a sequence diagram for printer registration;

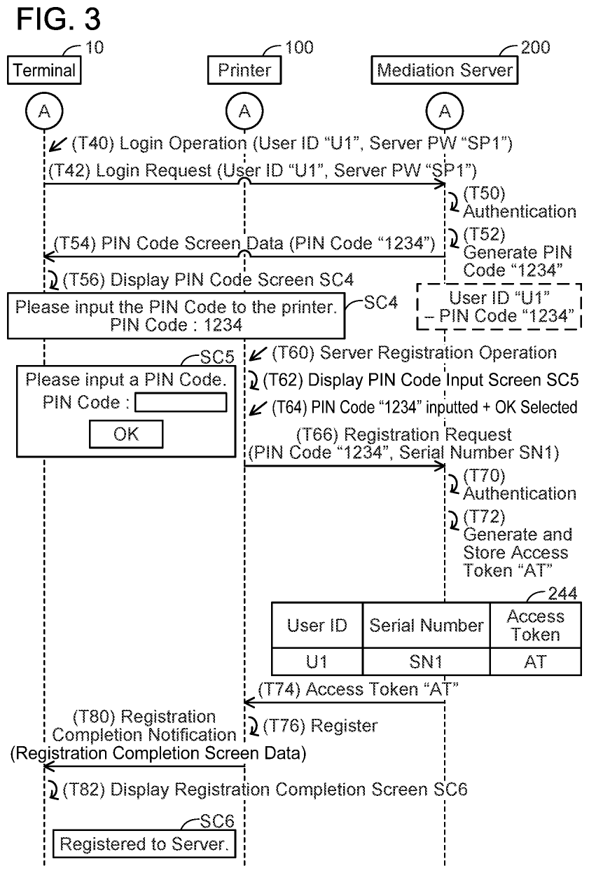

FIG. 3 illustrates a sequence diagram continued from FIG. 2;

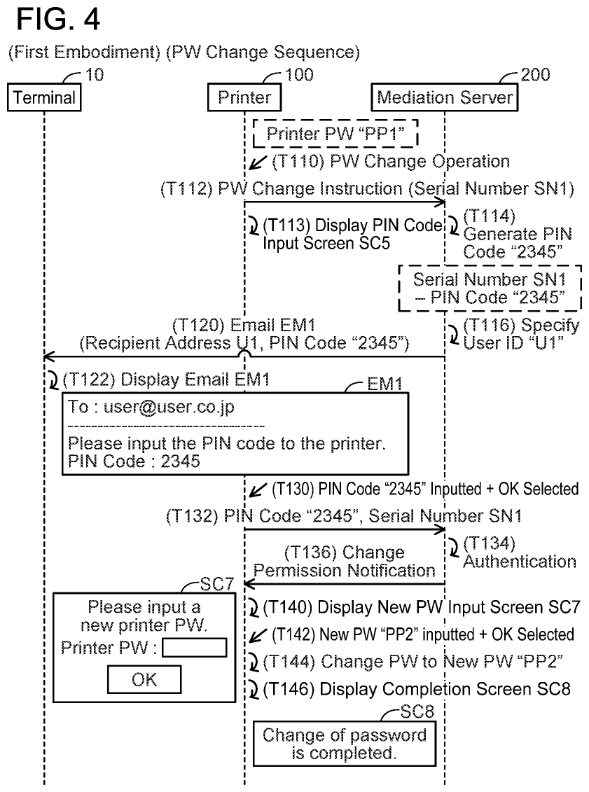

FIG. 4 illustrates a sequence diagram for password change;

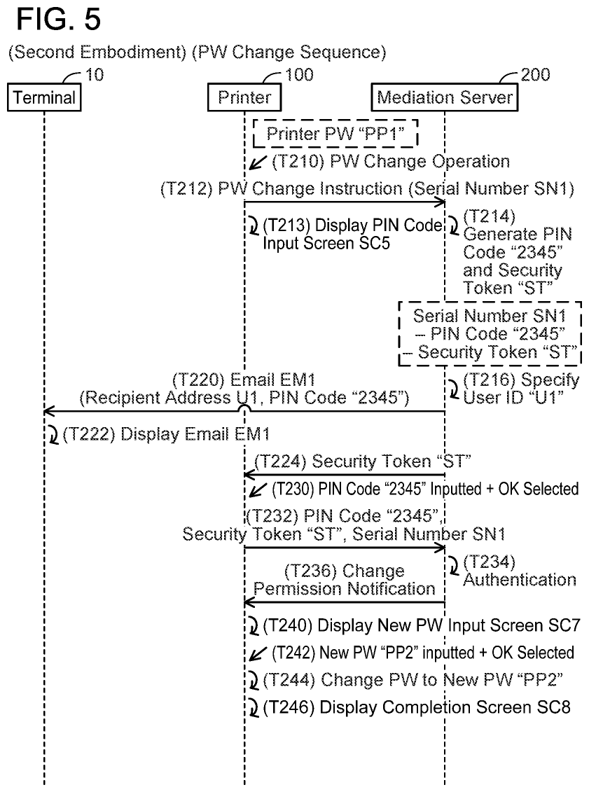

FIG. 5 illustrates a sequence diagram for password change;

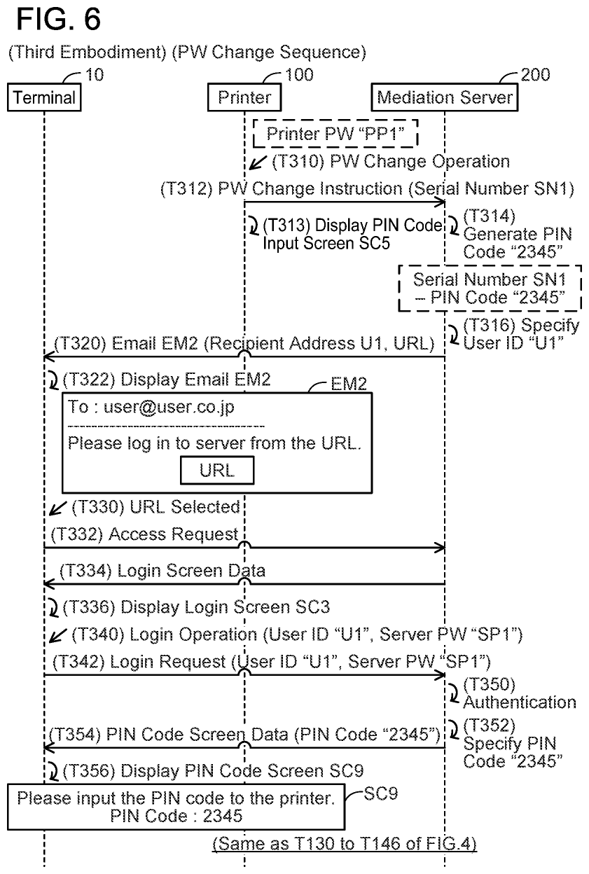

FIG. 6 illustrates a sequence diagram for password change;

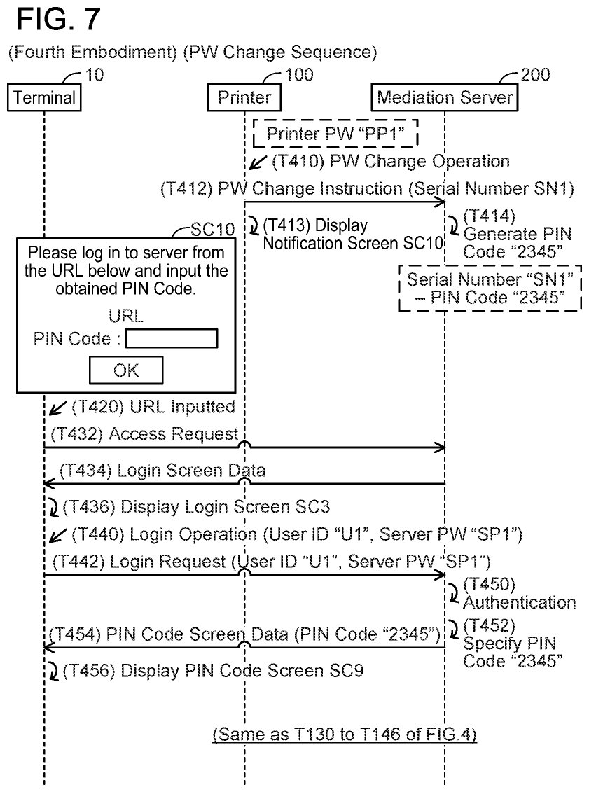

FIG. 7 illustrates a sequence diagram for password change;

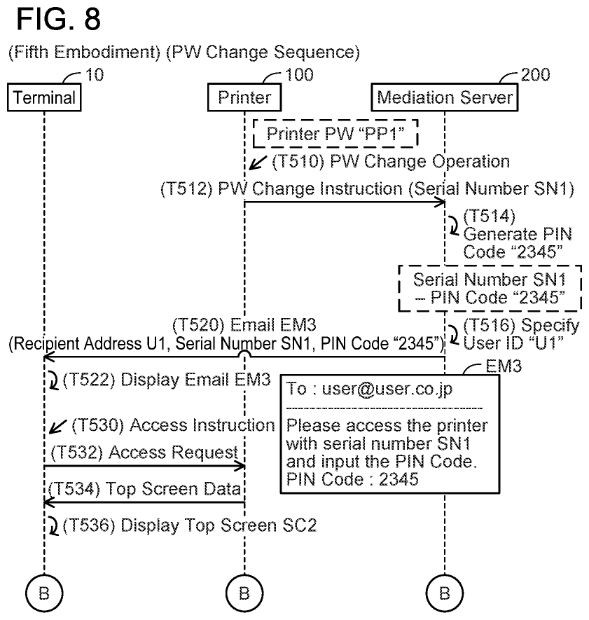

FIG. 8 illustrates a sequence diagram for password change; and

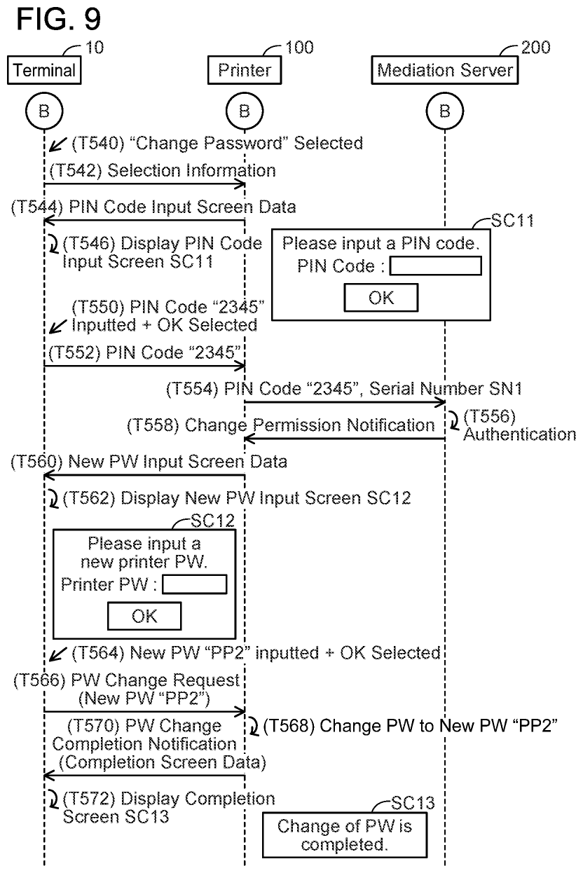

FIG. 9 illustrates a sequence diagram continued from FIG. 8.

### DETAILED DESCRIPTION

### First Embodiment

(Configuration of Communication System; FIG. 1)

As illustrated in FIG. 1, a communication system 2 comprises a terminal 10, a printer 100, and a mediation server 200. The terminal 10 and the printer 100 are connected to a LAN (local area network) 4 and are communicable with each other via the LAN 4. The LAN 4 is connected to the Internet 6, and the mediation server 200 is installed on the Internet 6. Thus, the terminal 10 and the printer 100 are communicable with the mediation server 200 via the Internet 6. Hereinafter, the mediation server 200 will be abbreviated as “server 200”. The disclosure herein provides a technology that allows an administrator of the printer 100 to change a printer password of the printer 100 in a situation where he/she has forgotten the printer password of the printer 100.

(Configuration of Terminal 10)

The terminal 10 may be a portable terminal such as a smartphone, a laptop PC, a tablet PC, or the like, or may be a stationary terminal such as a desktop PC or the like. The terminal 10 is used by the administrator who administrates the printer 100. The terminal 10 comprises an operation unit 12, a display unit 14, a communication interface 20, and a controller 30. Hereinafter, interface will be denoted as “I/F”.

The operation unit 12 is a button, a touch screen, or the like configured to be operated by the user. The user can input various instructions to the terminal 10 by operating the operation unit 12. The display unit 14 is a display for displaying various information. The communication I/F 20 is connected to the LAN 4.

The controller 30 comprises a CPU 32 and a memory 34. The CPU 32 executes various processes in accordance with an OS (operating system) program 40 stored in the memory 34. The memory 34 is configured of a volatile memory, a non-volatile memory, etc. The OS program 40 is a program for implementing basic operations of the terminal 10.

(Configuration of Printer 100)

The printer 100 is a peripheral device (e.g., a peripheral device of the terminal 10) configured to execute a print function. In a modification, the printer 100 may be a multifunctional device configured to execute a scan function, a FAX function, etc. in addition to the print function. The printer 100 has a serial number SN1 which is information for identifying the printer 100. The printer 100 comprises an operation unit 112, a display unit 114, a print executing unit 116, a communication I/F 120, and a controller 130.

The operation unit 112 is a button, a touch screen, or the like configured to be operated by the user. The user can input various instructions to the printer 100 by operating the operation unit 112. The display unit 114 is a display for displaying various information. The print executing unit 116 comprises a print mechanism of inkjet scheme, laser scheme, or the like. The communication I/F 120 is connected to the LAN 4.

The controller 130 comprises a CPU 132, a volatile memory 134A, and a non-volatile memory 134B. The CPU 132 executes various processes in accordance with a program 140 stored in the non-volatile memory 134B.

(Configuration of Server 200)

The server 200 mediates various communication for changing the password of the printer 100. The server 200 comprises a communication I/F 220 and a controller 230. The communication I/F 220 is connected to the Internet 6. In the present embodiment, the printer password is not notified to the server 200 from the printer 100. Thus, the printer password is not stored in the server 200.

The controller 230 comprises a CPU 232 and a memory 234. The CPU 232 executes various processes in accordance with a program 240 stored in the memory 234. The memory 234 is configured of a volatile memory, a non-volatile memory, etc. The memory 234 further stores an account table 242 and a device table 244.

The account table 242 stores one or more pieces of account information corresponding to one or more users. Each account information is information required to log in to the server 200. A user ID and a server password are associated with each other in each account information. Hereinafter, password will be denoted as “PW”. In the present embodiment, e-mail address(es) is(are) used as the user ID(s). In a modification, the user ID(s) may be character string(s) designated by the user(s), instead of e-mail address(es). In the example of FIG. 1, a user ID “user@user.co.jp” which is an e-mail address of the user of the terminal 10 (i.e., the administrator of the printer 100) and a server PW “SP1” are stored in association with each other. Hereinafter, the user ID “user@user.co.jp” will be simply denoted as the user ID “U1”.

The device table 244 stores one or more pieces of information related to one or more devices (e.g., printer(s)). In the device table 244, user ID(s), serial number(s), and Access Token(s) are stored in association with each other. Each Access Token is information used to execute communication between the server 200 and the device identified by the serial number associated with the Access Token. In the example of FIG. 1, the user ID “U1”, the serial number SN1, and an Access Token “AT” are stored in association with each other in the device table 244.

(Printer Registration Sequence; FIGS. 2 and 3)

Referring to FIGS. 2 and 3, a process for registering information related to the printer 100 in the server 200 will be described. Hereinafter, for easier understanding, steps executed by the CPUs of devices (e.g., 32, 132, 232) will be described with the devices (e.g., the terminal 10, the printer 100, the server 200) as the subjects of action rather than describing with the CPUs as the subjects of action. Further, since communication between the devices is each executed via their communication I/Fs (e.g., 20, 120, 220) unless otherwise stated, a phrase “via the communication I/F” will be omitted in the following description on communication between the devices.

In an initial state of FIG. 2, the account table 242 already stores account information for the user of the terminal 10 (i.e., the administrator of the printer 100) (i.e., the user ID “U1” and the server PW “SP1”). Further, in the initial state of FIG. 2, the device table 244 does not store information related to the printer 100 (i.e., the serial number and an Access Token) yet.

When the printer 100 accepts a power-on operation from the administrator in T10, it is turned on in T12. At this time, the printer 100 determines that information related to the printer 100 itself has not been registered in the server 200 yet. Specifically, the printer 100 determines that the information has not been registered in the server 200 because an Access Token has not been stored in the non-volatile memory 134B yet. In this case, the printer 100 causes the display unit 114 to display a notification screen SC1 in T14. The notification screen SC1 includes a message that prompts the user to register the information related to the printer 100 in the server 200.

When seeing the notification screen SC1, the administrator performs an operation for registering the information related to the printer 100 in the server 200 using the terminal 10. Specifically, the terminal 10 first accepts an access instruction for accessing a web server function of the printer 100 from the administrator in T20. This access instruction includes designation of an IP address (not illustrated) of the printer 100. In this case, the terminal 10 sends an access request to the printer 100 in T22 using a web browser program (not illustrated). The following steps executed by the terminal 10 are also executed by using the web browser program unless it is explained that other program(s) will be used.

When receiving the access request from the terminal 10 in T22, the printer 100 sends top screen data representing a top screen SC2 to the terminal 10 in T24.

When receiving the top screen data from the printer 100 in T24, the terminal 10 causes the display unit 14 to display the top screen SC2 in T26. The top screen SC2 includes the current status of the printer 100 (which is “Idle” in the example of FIG. 2) and a plurality of buttons for changing settings of the printer 100 (e.g., a “Register to Server” button, a “Change Password” button, etc.).

In T30, the terminal 10 accepts selection of the “Register to Server” button in the top screen SC2. In this case, the terminal 10 sends an access request to the server 200 in T32.

When receiving the access request from the terminal 10 in T32, the server 200 sends login screen data representing a login screen SC3 to the terminal 10 in T34.

When receiving the login screen data from the server 200 in T34, the terminal 10 causes the display unit 14 to display the login screen SC3 in T36. The login screen SC3 includes a message that prompts input of account information (i.e., a user ID and a server PW) for login to the server 200, a user ID entry field, a server PW entry field, an OK button, and a cancel button.

(Continuation from FIG. 2; FIG. 3)

The terminal 10 accepts a login operation from the administrator in T40 of FIG. 3. The login operation includes an operation of inputting the user ID “U1” and the server PW “SP1” in the login screen SC3. In this case, the terminal 10 sends the server 200 a login request including the inputted user ID “U1” and server PW “SP1” in T42.

When receiving the login request from the terminal 10 in T42, the server 200 executes authentication in T50. Specifically, the server 200 determines whether the combination of the user ID “U1” and the server PW “SP1” included in the received login request is in the account table 242 or not. Since this combination is in the account table 242 in the present case (see the initial state of FIG. 2), the server 200 determines that the authentication succeeds. In this case, in T52, the server 200 generates a PIN code “1234” and stores the PIN code “1234” in the memory 234 in association with the user ID “U1” included in the received login request. The server 200 then sends PIN code screen data representing a PIN code screen SC4 to the terminal 10 in T54. If the server 200 determines in T50 that the combination of the user ID and the server PW included in the received login request is not in the account table 242, that is, if the authentication fails, steps from T52 and onward are not executed.

When receiving the PIN code screen data from the server 200 in T54, the terminal 10 causes the display unit 14 to display the PIN code screen SC4 in T56. The PIN code screen SC4 includes the PIN code “1234” and a message that prompts input of the PIN code to a printer to be registered in the server 200 (which is the printer 100 in the present case). Thus, the administrator is able to know that the PIN code “1234” displayed in the PIN code screen SC4 should be inputted to the printer 100.

When the printer 100 accepts a server registration operation from the administrator who saw the PIN code screen SC4 in T60, it causes the display unit 114 to display a PIN code input screen SC5 in T62. The PIN code input screen SC5 includes a message that prompts input of a PIN code, a PIN code entry field, and an OK button.

When the printer 100 accepts input of the PIN code “1234” and selection of the OK button in the PIN code input screen SC5 in T64, it sends a registration request to the server 200 in T66. The registration request includes the inputted PIN code “1234” and the serial number SN1 of the printer 100.

When receiving the registration request from the printer 100 in T66, the server 200 executes authentication in T70. Specifically, the server 200 determines whether the PIN code “1234” included in the received registration request has been already stored in the memory 234 or not. Since the PIN code “1234” has been already stored in the memory 234 in the present case (see T52), the server 200 determines that the authentication succeeds. In this case, the server 200 generates an Access Token “AT” in T72. Hereinafter, the Access Token “AT” may be simply denoted as “AT”. The server 200 then specifies the user ID “U1” stored in the memory 234 in association with the PIN code “1234” (see T52). Then, the server 200 stores the specified user ID “U1”, the serial number SN1 included in the registration request, and the generated Access Token “AT” in association with each other in the device table 244. In this manner, the information related to the printer 100 is registered in the server 200.

The server 200 sends the “AT” to the printer 100 in T74. If the PIN code included in the registration request has not been stored in the memory 234 in T70, that is, if the authentication fails, the server 200 dos not execute steps from T72 and onward.

When receiving the “AT” from the server 200 in T74, the printer 100 registers the “AT” in the non-volatile memory 134B in T76. As a result, a so-called continuous connection is established between the printer 100 and the server 200, although this is not illustrated. By using the continuous connection, the server 200 can send signals to the printer 100 beyond the firewall of the LAN 4 where the printer 100 belongs, without receiving requests from the printer 100. That is, the continuous connection allows for server-push communication. The continuous connection is a connection according to, for example, XMPP (Extensible Messaging and Presence Protocol).

When the registration of the “AT” is completed, the printer 100 sends the terminal 10 a registration completion notification indicating that the registration in the server 200 has been completed in T80. The registration completion notification includes registration completion screen data representing a registration completion screen SC6.

When receiving the registration completion notification from the printer 100 in T80, the terminal 10 causes the display unit 14 to display the registration completion screen SC6 in T82. The registration completion screen SC6 includes a message indicating that the registration in the server 200 has been completed. The administrator is able to know that the registration in the server 200 has been completed by seeing the registration completion screen SC6.

(PW Change Sequence; FIG. 4)

Referring to FIG. 4, a process for changing the PW of the printer 100 will be described. The process of FIG. 4 is executed after the process of FIG. 3 has been completed. In an initial state of FIG. 4, the printer PW of the printer 100 is a printer PW “PP1”. The process of FIG. 4 is executed, for example, in a case where the administrator has forgotten the printer PW “PP1” of the printer 100.

When the printer 100 accepts a PW change operation from the administrator in T110, it sends a PW change instruction to the server 200 in T112. The PW change instruction includes the serial number SN1 of the printer 100. When the printer 100 accepts the PW change operation from the administrator in T110, it also causes the display unit 114 to display the PIN code input screen SC5 (see FIG. 3) in T113.

When receiving the PW change instruction from the printer 100 in T112, the server 200 generates a PIN code “2345” and stores the serial number SN1 included in the PW change instruction and the generated PIN code “2345” in association with each other in the memory 234 in T114.

In T116, the server 200 specifies the user ID “U1”. Specifically, the server 200 specifies the e-mail address “U1” which is the user ID associated with the serial number SN1 included in the PW change instruction in the device table 244. If no user IDs are associated with the serial number SN1 in the device table 244, the server 200 does not execute steps from T120 and onward.

In T120, the server 200 sends an e-mail EM1 including the PIN code “2345” generated in T114 to the e-mail address “U1” which is the specified user ID.

The administrator has had the terminal 10 store in advance e-mail settings for receiving the e-mail EM1 sent to the e-mail address “U1”. Thus, the terminal 10 receives the e-mail EM1 from the server 200 in T120. In this case, the terminal 10 displays the e-mail EM1 using an e-mailer program (not illustrated) in T122. The body of the e-mail EM1 includes the PIN code “2345” and a message that prompts input of the PIN code to a printer for which the PW is to be changed (which is the printer 100 in the present case). By seeing the e-mail EM1, the administrator is able to know that the PIN code “2345” included in the e-mail EM1 should be inputted to the printer 100.

In T130, the printer 100 accepts input of the PIN code “2345” and selection of the OK button in the PIN code input screen SC5 (see T113) from the administrator who saw the e-mail EM1. In this case, the printer 100 sends the inputted PIN code “2345” and the serial number SN1 of the printer 100 to the server 200 in T132. As described, the PIN code “2345” is directly inputted to the printer 100 from the administrator. It is highly probable that a person who can directly input the PIN code “2345” to the printer 100 is a legitimate user of the printer 100. Thus, the PW of the printer 100 can be changed securely.

When receiving the PIN code “2345” and the serial number SN1 from the printer 100 in T132, the server 200 executes authentication in T134. Specifically, the server 200 determines whether the combination of the received PIN code “2345” and serial number SN1 is in the memory 234 or not. Since this combination is in the memory 234 in the present case (see T114), the server 200 determines that the authentication succeeds. In this case, the server 200 sends a change permission notification to the printer 100 in T136. The change permission notification is a notification to permit the printer 100 to change its PW. If the combination above is not in the memory 234 in T134, that is, if the authentication fails, the server 200 does not execute steps from T136 and onward.

When receiving the change permission notification from the server 200 in T136, the printer 100 causes the display unit 114 to display a new PW input screen SC7 in T140. The new PW input screen SC7 includes a message that prompts input of a new printer PW, a printer PW entry field, and an OK button.

When the printer 100 accepts, from the administrator, input of a new PW “PP2” to the printer PW entry field and selection of the OK button in T142, it changes the printer PW from “PP1” to “PP2” in T144. As described, the administrator can change the printer PW from “PP1” to “PP2” by inputting the new PW “PP2” to the new PW input screen SC7 displayed at the printer 100. The printer 100 then causes the display unit 114 to display a completion screen SC8 in T146. The completion screen SC8 includes a message indicating that the printer PW change has been completed. The administrator is able to know that the printer PW change has been completed by seeing the completion screen SC8.

### Effects of First Embodiment

As described, when accepting the PW change operation from the administrator (T110), the printer 100 sends the PW change instruction to the server 200 (T112). When receiving the PW change instruction from the printer 100, the server 200 sends the e-mail EM1 including the PIN code “2345” to the terminal 10 (T120). Thereafter, when the PIN code “2345” is inputted to the printer 100 by the administrator (T130), the printer 100 sends the PIN code “2345” to the server 200 (T132). When receiving the PIN code “2345” from the printer 100, the server 200 sends the change permission notification to the printer 100 (T136). The printer 100 receives the change permission notification from the server 200 and changes the printer PW (T144) in response to the new PW “PP2” being inputted. As described, changing the PW of the printer 100 is permitted only in a case where the PIN code “2345” which was sent from the server 200 to the terminal 10 is sent from the printer 100 to the server 200 and the printer 100 receives the change permission notification. Thus, the PW of the printer 100 can be securely changed.

Here, a first comparative example can be considered in which the PW of the printer 100 is changed without using the terminal 10 nor the server 200. In this comparative example, the PW of the printer 100 can be changed only by performing the PW change operation to the printer 100 (see T110 in FIG. 4). That is, anyone who can physically access the printer 100 can change the PW of the printer 100. Contrary to this, in the present embodiment, it is required to input the PIN code “2345” to the printer 100 in order to change the PW of the printer 100. The PIN code “2345” is sent to the e-mail address of a user registered in the server 200 (user having high probability of being a legitimate user of the printer 100). That is, in the present embodiment, it is highly probable that the printer PW cannot be changed if the user is not a user registered in the server 200. Thus, the PW of the printer 100 can be changed more securely.

Further, in the present embodiment, the administrator does not need to input the old PW “PP1” to the printer 100 to change the PW of the printer 100 to the new PW “PP2”. Thus, even when the administrator has forgotten the old PW “PP1”, he/she can change the PW of the printer 100.

Here, a second comparative example can be considered in which the PW is changed using a question for which the answer is determined in advance by the administrator (so-called “secret question”) in a situation where the administrator has forgotten the old PW. In the second comparative example, the administrator inputs the answer to the secret question, and changing the PW is permitted when authentication for the answer succeeds. On the other hand, in the present embodiment, the administrator can change the printer PW even when he/she does not remember the old printer PW, so long as he/she obtains the PIN code “2345” by seeing the e-mail EM1 sent to his/her terminal. Generally, the secret question is a question related to personal information, and thus the answer to the secret question may be guessed, for example, from social media of the administrator. On the other hand, since the PIN code “2345” is included in the e-mail EM1 sent to the e-mail address of the administrator who has been registered in the server 200, the PIN code “2345” is information only the administrator can obtain. Thus, the PIN code “2345” included in the e-mail EM1 is less likely to be known by a third party than the answer to the secret question. Thus, according to the present embodiment, the printer PW can be changed more securely in a situation where the administrator has forgotten the old printer PW, compared to the second comparative example.

Further, a third comparative example can be considered in which the server 200 does not store the serial number SN1 and the PIN code “2345” in association with each other but stores only the PIN code “2345”. In this comparative example, when the PIN code “2345” is inputted to a printer different from the printer 100 for which the administrator wishes to change the PW, the PIN code “2345” is sent from this different printer to the server 200. In this case, the server 200 determines that the authentication succeeds since the PIN code “2345” has been stored and then sends the change permission notification to the different printer. Thus, in the third comparative example, the PW of the printer different from the printer 100 for which the administrator wishes to change the PW may be changed. On the other hand, in the present embodiment, the serial number SN1 of the printer 100 and the PIN code “2345” are stored in association with each other (T114 in FIG. 4) and the server 200 determines whether the combination of the serial number SN1 and the PIN code “2345” has been stored or not (T134). Thus, when the PIN code “2345” is inputted to the printer different from the printer 100 for which the administrator wishes to change the PW, the serial number of the different printer and the PIN code “2345” are sent from the different printer to the server 200. In this case, the server 200 determines that the authentication fails since the combination of the serial number of the different printer and the PIN code “2345” has not been stored and does not send the change permission notification to the different printer. As described, according to the present embodiment, only the printer PW of the printer 100 for which the administrator wishes to change the PW can be changed. In a modification, the server 200 may not store the serial number SN1 and the PIN code “2345” in association with each other.

(Correspondence Relationships)

The terminal 10, the printer 100, and the server 200 are examples of “terminal device”, “communication device (second external device)”, and “server”, respectively. The display unit 14 of the terminal 10 is an example of “display unit”. The PIN code “2345” and the PIN code “1234” are examples of “first authentication information” and “specifying information”, respectively. The combination of the user ID “U1” and the server PW “SP1” and the user ID “U1” are examples of “target user information” and “e-mail address”, respectively. The serial number SN1 is an example of “identification information”. The PW change operation in T110 of FIG. 4 is an example of “predetermined instruction”. The e-mail EM1 is an example of “first e-mail”. The printer PW “PP1” and the printer PW “PP2” are examples of “old password” and “new password”, respectively.

T66 in FIG. 3 is an example of “send a registration request” by the “communication device”. T110, T112, T130, T136, T140, and T144 in FIG. 4 are examples of “accept a predetermined instruction”, “send a change instruction”, “accept input of the first authentication information”, “receive a change permission notification”, “cause a display unit to display an input screen”, and “change the password” by the “communication device”, respectively.

T66 and T72 in FIG. 3 are examples of “receive a registration request” and “store the identification information and the target user information” by the “server”, respectively. T112, T120, T132, and T136 in FIG. 4 are examples of “receive a change instruction”, “send first authentication information”, “receive the first authentication information”, and “send a change permission notification” by the “server”, respectively.

### Second Embodiment; FIG. 5

Referring to FIG. 5, a second embodiment will be described. The second embodiment differs from the first embodiment in that a Security Token is further used. An initial state of FIG. 5 is the same as the initial state of FIG. 4. T210 to T213 in FIG. 5 are the same as T110 to T113 in FIG. 4.

The server 200 generates a PIN code “2345” and a Security Token “ST” in T214. Hereinafter, the Security Token “ST” may be simply denoted as “ST”. After generating the PIN code “2345” and the “ST”, the server 200 stores the serial number SN1 included in the PW change instruction (see T212 in FIG. 5), the generated PIN code “2345”, and the generated “ST” in association with each other in the memory 234. T216 to T222 are the same as T116 to T122 in FIG. 4.

The server 200 sends the generated “ST” to the printer 100 in T224 using the continuous connection (not illustrated) established between the printer 100 and the server 200. As a result, the printer 100 stores the “ST” received from the server 200 in the volatile memory 134A, although this is not illustrated. In a modification, the printer 100 may store the “ST” in the non-volatile memory 134B.

T230 is the same as T130 in FIG. 4. In T232, the printer 100 sends the inputted PIN code “2345”, the “ST” stored in the volatile memory 134A, and the serial number SN1 of the printer 100 to the server 200.

When receiving the PIN code “2345”, the “ST”, and the serial number SN1 from the printer 100 in T232, the server 200 executes authentication in T234. Specifically, the server 200 determines whether the combination of the received PIN code “2345”, the received “ST”, and the received serial number SN1 is in the memory 234 or not. Since this combination is in the memory 234 in the present case (see T214), the server 200 determines that the authentication succeeds. In this case, the server 200 sends the change permission notification to the printer 100 in T236. If the combination above is not in the memory 234, that is, the authentication fails in T234, the server 200 does not execute steps from T236 and onward. T240 to T246 are the same as T140 to T146 in FIG. 4.

(Effects of Second Embodiment)

The PW of the printer 100 can be changed securely also in the second embodiment, as with the first embodiment. Especially, the “ST” is information generated by the server 200 when the server 200 receives the PW change instruction from the printer 100 (T212 in FIG. 5). The “ST” is sent to the printer 100 (T224) but is not displayed at the printer 100. That is, the “ST” is information that is not obtained by the user. On the other hand, the serial number SN1 is information that is displayed, for example, on the housing or in the manual of the printer 100, that is, information that can be obtained by the user.

Here, a situation can be considered in which a third party obtains the PIN code “2345” and the serial number SN1 of the printer 100 for which the administrator wishes to change the PW and the third party inputs the serial number SN1 and the PIN code “2345” to a printer different from the printer 100. In this case, the different printer sends the PIN code “2345” and the serial number SN1 to the server 200. Under such a situation, according to the first embodiment, the server 200 determines that the authentication succeeds since the combination of the PIN code “2345” and the serial number SN1 received from the different printer has been stored and then sends the change permission notification to the different printer. As a result, the PW of the different printer may be changed by the third party. On the other hand, according to the second embodiment, the different printer does not store the “ST”, and as described, the third party cannot obtain the “ST”. Thus, the server 200 determines that the authentication fails since it does not receive the “ST” from the different printer. As a result, the server 200 does not send the change permission notification to the different printer. Thus, the PW of the different printer cannot be changed by the third party. In this manner, according to the second embodiment, it is possible to prevent the PW of the different printer to be changed by the third party even when the PIN code “2345” and the serial number SN1 are obtained by the third party.

(Correspondence Relationships)

The Security Token “ST” is an example of “second authentication information”. T224 in FIG. 5 is an example of “receive second authentication information” by the “communication device”. T214 and T224 in FIG. 5 are examples of “store the first authentication information and second authentication information” and “send the second authentication information” by the “server”, respectively.

### Third Embodiment; FIG. 6

Referring to FIG. 6, a third embodiment will be described. The third embodiment differs from the first embodiment in that an e-mail that includes a Uniform Resource Locator (URL) representing a location of a login screen for logging in to the server 200 within the server 200 is sent. An initial state of FIG. 6 is the same as the initial state of FIG. 4. T310 to T316 in FIG. 6 are the same as T110 to T116 in FIG. 4.

In T320, the server 200 sends an e-mail EM2 including a URL to the e-mail address “U1” which is the user ID specified in T316. The URL represents a location of login screen data indicating the login screen SC3 (see T36 in FIG. 2) within the server 200.

When the terminal 10 receives the e-mail EM2 from the server 200 in T320, it displays the e-mail EM2 using an e-mailer program in T322. The body of the e-mail EM2 includes the URL above and a message that prompts the user to log in to the server 200 via the URL. The administrator is able to know that he/she should log in to the server 200 by seeing the e-mail EM2 and obtain the PIN code “2345” by logging in to the server 200. Especially, since the e-mail EM2 includes the URL, the administrator does not need to input the URL to access the server 200.

When the terminal 10 accepts an operation of selecting the URL in the e-mail EM2 from the administrator in T330, it sends an access request to the server 200 in T332. T332 to T336 are the same as T32 to T36 in FIG. 2. T340 to T350 are the same as T40 to T50 in FIG. 3.

The server 200 specifies the PIN code “2345” in T352. Specifically, the server 200 first specifies the serial number SN1 associated with the user ID “U1”, for which the authentication succeeded in T350, in the device table 244. The server 200 then specifies the PIN code “2345” associated with the specified serial number SN1 (see T314). After specifying the PIN code “2345”, the server 200 sends PIN code screen data representing a PIN code input screen SC9 to the terminal 10 in T354. The PIN code screen data includes the PIN code “2345”.

When receiving the PIN code screen data from the server 200 in T354, the terminal 10 causes the display unit 14 to display the PIN code screen SC9 in T356. The PIN code screen SC9 includes the PIN code “2345” and a message that prompts input of the PIN code to a printer for which the PW is to be changed (which is the printer 100 in the present case). Thus, the administrator is able to know that the PIN code “2345” displayed in the PIN code screen SC9 should be inputted to the printer 100. The process after this is the same as T130 to T146 in FIG. 4.

### Effects of Third Embodiment

The PW of the printer 100 can be changed securely also in the third embodiment, as with the first embodiment. Especially in the third embodiment, two-factor authentication that includes the login to the server 200 (T340 to T350) and the authentication of the PIN code “2345” (T134 of FIG. 4 referenced n FIG. 6) is executed when the PW of the printer 100 is to be changed. Thus, the PW of the printer 100 can be changed more securely.

(Correspondence Relationships)

The e-mail EM2, the URL, and the login screen SC3 are examples of “second e-mail”, “location information”, and “login screen”, respectively. T320 in FIG. 6 is an example of “a second e-mail including location information is sent” by the “server”.

### Fourth Embodiment; FIG. 7

Referring to FIG. 7, a fourth embodiment will be described. The fourth embodiment differs from the first embodiment in that the printer 100 displays a notification screen that prompts the user to log in to the server 200. An initial state of FIG. 7 is the same as the initial state of FIG. 4. T410 and T412 in FIG. 7 are the same as T110 and T112 in FIG. 4.

The printer 100 causes the display unit 114 to display a notification screen SC10 in T413. The notification screen SC10 includes a message that prompts the user to log in to the server 200, a URL that indicates a location of login screen data representing the login screen SC3 (see T36 in FIG. 2) within the server 200, a PIN code entry field, and an OK button. The administrator is able to know that he/she should log in to the server 200 by seeing the notification screen SC10 and obtain the PIN code “2345” by logging in to the server 200. T414 is the same as T114 in FIG. 4.

When the terminal 10 accepts an operation of inputting the URL displayed in the notification screen SC10 from the administrator who saw the notification screen SC10 in T420, it sends an access request to the server 200 in T432. T432 to T456 are the same as T332 to T356 in FIG. 6. Thereafter, steps same as T130 to T146 in FIG. 4 are executed.

(Effects of Fourth Embodiment)

The PW of the printer 100 can be changed securely also in the fourth embodiment, as with the first embodiment. The display unit 114 of the printer 100 is an example of “output unit”. The notification screen SC10 is an example of “notification information”. T413 in FIG. 7 is an example of “cause the output unit to output notification information” by the “communication device”.

### Fifth Embodiment; FIGS. 8 and 9

Referring to FIGS. 8 and 9, a fifth embodiment will be described. The fifth embodiment differs from the first embodiment in that the PW of the printer 100 is changed via a web server of the printer 100. An initial state of FIG. 8 is the same as the initial state of FIG. 4. T510 and T512 in FIG. 8 are the same as T110 and T112 in FIG. 4. T514 and T516 are the same as T114 and T116 in FIG. 4.

In T520, the server 200 sends an e-mail EM3 including the serial number SN1 of the printer 100 and the generated PIN code “2345” to the e-mail address “U1” which is the user ID specified in T516.

When the terminal 10 receives the e-mail EM3 from the server 200 in T520, it displays the e-mail EM3 in T522 using an e-mailer program. The body of the e-mail EM3 includes the serial number SN1 of the printer 100, the PIN code “2345”, and a message that prompts the user to access the web server of the printer 100 identified by the serial number SN1 and input the PIN code. T530 to T536 are the same as T20 to T26 in FIG. 2.

(Continuation from FIG. 8; FIG. 9)

The terminal 10 accepts selection of the “Change Password” button in the top screen SC2 (see FIG. 2) in T540 of FIG. 9. In this case, the terminal 10 sends selection information indicating that the “Change Password” button was selected to the printer 100 in T542.

When receiving the selection information from the terminal 10 in T542, the printer 100 sends PIN code input screen data representing a PIN code input screen SC11 to the terminal 10 in T544.

When receiving the PIN code input screen data from the printer 100 in T544, the terminal 10 causes the display unit 14 to display the PIN code input screen SC11 in T546. The PIN code input screen SC11 includes a message that prompts input of a PIN code, a PIN code entry field, and an OK button.

In T550, the terminal 10 accepts input of the PIN code “2345” to the PIN code entry field and selection of the OK button in the PIN code input screen SC11. In this case, the terminal 10 sends the inputted PIN code “2345” to the printer 100 in T552.

When receiving the PIN code “2345” from the terminal 10 in T552, the printer 100 sends the PIN code “2345” and the serial number SN1 of the printer 100 to the server 200 in T554.

When receiving the PIN code “2345” and the serial number SN1 from the printer 100 in T554, the server 200 executes authentication in T556. T556 is the same as T134 in FIG. 4. T558 is the same as T136 in FIG. 4.

When the printer 100 receives the change permission notification from the server 200 in T558, it sends new PW input screen data representing a new PW input screen SC12 to the terminal 10 in T560.

When receiving the new PW input screen data from the printer 100 in T560, the terminal 10 causes the display unit 14 to display the new PW input screen SC12 in T562. The new PW input screen SC12 includes a message that prompts input of a new printer PW, a printer PW entry field, and an OK button.

When the terminal 10 accepts input of a new PW “PP2” to the printer PW entry field and selection of the OK button in T564, it sends a PW change request to the printer 100 in T566. The PW change request includes the inputted new PW “PP2”.

When receiving the PW change request from the terminal 10 in T566, the printer 100 changes the printer PW from “PP1” to “PP2” in T568. The printer 100 then sends the terminal 10 a PW change completion notification that includes completion screen data representing a completion screen SC13 in T570.

When receiving the PW change completion notification from the printer 100 in T570, the terminal 10 causes the display unit 14 to display the completion screen SC13 in T572. The completion screen SC13 includes a message indicating that the PW change has been completed. The administrator is able to know that the PW change has been completed by seeing the completion screen SC13.

### Effects of Fifth Embodiment

The PW of the printer 100 can be changed securely also in the fifth embodiment, as with the first embodiment. Especially, according to the present embodiment, the administrator does not need to approach the printer 100 to input the PIN code “2345” to the printer 100 since the administrator does not directly input the PIN code “2345” to the printer 100. Thus, convenience is improved for the administrator.

(Correspondence Relationships)

The terminal 10 is an example of “first external device”. The display unit 14 of the terminal 10 is an example of “display unit”. T560 in FIG. 9 is an example of “cause a display unit to display an input screen” by the “communication device”.

(Modification 1) The printer 100 may send a PW change instruction that includes the new PW “PP2” as well as the serial number SN1 to the server 200 in T112 of FIG. 4. In this case, the server 200 may store the serial number SN1, the PIN code “2345”, and the new PW “PP2” in association with each other in T114. The server 200 then may send a change permission notification including the new PW “PP2” associated with the PIN code “2345” to the printer 100 in T136. In this case, the printer 100 can omit T140 and T142. In the present modification, “cause a display unit to display an input screen” by the “communication device” can be omitted.

(Modification 2) The terminal 10 may input the PIN code “2345” to the printer 100 via a Near Field Communication (NFC) connection. Specifically, the administrator may bring the terminal 10 that has received the PIN code “2345” closer to the printer 100 instead of step T130 in FIG. 4. In this case, an NFC connection is established between the terminal 10 and the printer 100 and the PIN code “2345” may be inputted to the printer 100 using this NFC connection. In another modification, the terminal 10 may input the PIN code “2345” to the printer 100 via a Bluetooth (registered trademark, BT) connection. In yet another modification, the terminal 10 may input the PIN code “2345” to the printer 100 via a Wi-Fi Direct (registered trademark, WFD) connection. Generally, a method of inputting the “first authentication information” to the “communication device” is not particularly limited.

(Modification 3) The terminal 10 may display a PIN code input screen on the display unit 14 when the “Register to Server” button is selected in T30 of FIG. 2. Then, when the terminal 10 accepts input of the PIN code “1234” and input of the serial number SN1 of the printer 100 to be registered in the server 200 in the PIN code input screen, the terminal 10 may send a registration request including these information to the server 200. In the present modification, the terminal 10 is an example of the “second external device”. Furter, in the present modification, “send a registration request” by the “communication device” can be omitted.

(Modification 4) T32 to T36 in FIGS. 2 and T40 to T56 in FIG. 3 may be omitted. In this case, the printer 100 may display a screen for input of a user ID and a server PW when accepting the server registration operation (T60 in FIG. 3). In this case, the printer 100 may send a registration request including the inputted user ID and server PW and the serial number SN1 to the server 200. In the present modification, the user ID and the server PW are an example of the “specifying information”.

(Modification 5) The printer 100 may cause the print executing unit 116 to print the URL on print medium in T413 of FIG. 7 instead of causing the display unit 114 to display the notification screen SC10. In this case, the printer 100 may cause the display unit 114 to display a screen including a PIN code entry field after the URL has been printed on the print medium. In the present modification, the print executing unit 116 is an example of the “output unit” and causing the print executing unit 116 to print the URL on the print medium is an example of “cause the output unit to output notification information” by the “communication device”.

(Modification 6) The administrator may perform the processes of FIGS. 8 and 9 using a terminal different from the terminal 10. In the present modification, this different terminal is an example of the “first external device”.

(Modification 7) In the embodiments above, the processes of FIGS. 2 to 9 are implemented by software (e.g., the OS program 40, the programs 140, 240), however, at least one of these processes may be implemented by hardware such as a logic circuit.

What is claimed is:

1. A communication device comprising a controller, wherein
the controller is configured to:
accept a predetermined instruction for changing a password of the communication device from a user;
in a case where the predetermined instruction is accepted, send a change instruction including identification information for identifying the communication device to a server, wherein the server stores the identification information and target user information corresponding to the user of a terminal device different from the communication device in association with each other, and the change instruction is a signal to instruct the server to send first authentication information to the terminal device by using the target user information stored in association with the identification information included in the change instruction;
after the first authentication information has been sent from the server to the terminal device, accept input of the first authentication information from the user;
in a case where the input of the first authentication information is accepted, send the first authentication information to the server;
in a case where the first authentication information is sent to the server, receive a change permission notification from the server; and
in a case where the change permission notification is received from the server, change the password of the communication device.

2. The communication device as in claim 1, wherein
the controller is further configured to:
in the case where the change permission notification is received from the server, cause a display unit to display an input screen for input of a new password, and
in a case where the new password is inputted in the input screen, the controller is configured to change the password of the communication device from its old password to the new password.

3. The communication device as in claim 1, wherein
the controller is further configured to:
receive second authentication information from the server in a case where the change instruction is sent to the server,
in the case where the input of the first authentication information is accepted, the controller is configured to send the first authentication information and the second authentication information to the server, and
in a case where the first authentication information and the second authentication information are sent to the server, the controller is configured to receive the change permission notification from the server.

4. The communication device as in claim 1, wherein
the target user information includes an e-mail address of the user of the terminal device, and
the change instruction is a signal to instruct the server to send a first e-mail including the first authentication information to the e-mail address included in the target user information stored in association with the identification information included in the change instruction.

5. The communication device as in claim 1, wherein
the target user information includes an e-mail address of the user of the terminal device,
the change instruction is a signal to instruct the server to send a second e-mail including location information to the e-mail address included in the target user information stored in association with the identification information included in the change instruction, wherein the location information indicates a location of login screen data representing a login screen for login to the server, and
in a case where the server is logged in by the terminal device after the login screen has been displayed at the terminal device, the first authentication information is sent to the terminal device.

6. The communication device as in claim 1, further comprising an output unit, wherein
the controller is further configured to:
in the case where the predetermined instruction is accepted, cause the output unit to output notification information to prompt the user to log in to the server, and
in a case where the server is logged in by the terminal device after the notification information has been outputted, the first authentication information is sent to the terminal device.

7. The communication device as in claim 1, further comprising an operation unit, wherein
the controller is configured to accept the input of the first authentication information by the operation unit being operated by the user.

8. The communication device as in claim 1, wherein
the communication device has a web server function, and
the controller is configured to accept the input of the first authentication information via the web server function of the communication device by a first external device different from the communication device being used by the user.

9. The communication device as in claim 1, wherein
the controller is further configured to:
send a registration request including the identification information and specifying information for specifying the target user information to the server, wherein the registration request is a signal to request the server to store the identification information and the target user information specified by the specifying information in association with each other.

10. A non-transitory computer-readable recording medium storing computer-readable instructions for a communication device,
wherein the computer-readable instructions, when executed by a processor of the communication device, cause the communication device to:
accept a predetermined instruction for changing a password of the communication device from a user;
in a case where the predetermined instruction is accepted, send a change instruction including identification information for identifying the communication device to a server, wherein the server stores the identification information and target user information corresponding to a user of a terminal device different from the communication device in association with each other, and the change instruction is a signal to instruct the server to send first authentication information to the terminal device by using the target user information stored in association with the identification information included in the change instruction;
accept input of the first authentication information from the user after the first authentication information has been sent from the server to the terminal device;
in a case where the input of the first authentication information is accepted, send the first authentication information to the server;
in a case where the first authentication information is sent to the server, receive a change permission notification from the server; and
in a case where the change permission notification is received from the server, change the password of the communication device.

11. A non-transitory computer-readable recording medium storing computer-readable instructions for a server,
the server comprising:
a memory configured to store identification information for identifying a communication device and target user information corresponding to a user of a terminal device different from the communication device in association with each other; and
a processor,
wherein the computer-readable instructions, when executed by the processor, cause the server to:
receive a change instruction including the identification information from the communication device;
in a case where the change instruction is received from the communication device, send first authentication information to the terminal device by using the target user information stored in association with the identification information included in the change instruction, wherein the first authentication information is inputted to the communication device by the user of the terminal device after the first authentication information has been sent to the terminal device;
in a case where the first authentication information is inputted to the communication device, receive the first authentication information from the communication device; and
in a case where the first authentication information is received from the communication device, send a change permission notification to the communication device, wherein the change permission notification is a notification to permit the communication device to change a password of the communication device.

12. The non-transitory computer-readable recording medium as in claim 11, wherein
the computer-readable instructions, when executed by the processor, further cause the server to:
store the first authentication information and second authentication information different from the first authentication information in association with each other in the memory; and
in the case where the change instruction is received from the communication device, send the second authentication information to the communication device identified by the identification information,
in a case where the second authentication information is sent to the communication device and the first authentication information is inputted to the communication device, the first authentication information and the second authentication information are received from the communication device, and
in a case where the first authentication information and the second authentication information have been received from the communication device and the received first authentication information and the received second authentication information are stored in association with each other in the memory, the change permission notification is sent to the communication device.

13. The non-transitory computer-readable recording medium as in claim 11, wherein
the target user information includes an e-mail address of the user of the terminal device, and
in the case where the change instruction is received from the communication device, a first e-mail including the first authentication information is sent to the e-mail address included in the target user information stored in association with the identification information included in the change instruction.

14. The non-transitory computer-readable recording medium as in claim 11, wherein
in a case where the server is logged in by the terminal device, the first authentication information is sent to the terminal device.

15. The non-transitory computer-readable recording medium as in claim 14, wherein
the target user information includes an e-mail address of the user of the terminal device,
in the case where the change instruction is received from the communication device, a second e-mail including location information is sent to the e-mail address included in the target user information stored in association with the identification information included in the change instruction, wherein the location information indicates a location of login screen data representing a login screen for login to the server, and
in a case where the server is logged in by the terminal device after the login screen has been displayed at the terminal device, the first authentication information is sent to the terminal device.

16. The non-transitory computer-readable recording medium as in claim 11, wherein
the computer-readable instructions, when executed by the processor, further cause the server to:
receive a registration request including the identification information and specifying information for specifying the target user information from a second external device; and
in a case where the registration request is received from the second external device, store the identification information and the target user information specified by the specifying information in association with each other in the memory.

17. A server comprising:
a memory configured to store identification information for identifying a communication device and target user information corresponding to a user of a terminal device different from the communication device in association with each other; and
a controller,
wherein the controller is configured to:
receive a change instruction including the identification information from the communication device;
in a case where the change instruction is received from the communication device, send first authentication information to the terminal device by using the target user information stored in association with the identification information included in the change instruction, wherein the first authentication information is inputted to the communication device by the user of the terminal device after the first authentication information has been sent to the terminal device;
in a case where the first authentication information is inputted to the communication device, receive the first authentication information from the communication device; and
in a case where the first authentication information is received from the communication device, send a change permission notification to the communication device, wherein the change permission notification is a notification to permit the communication device to change a password of the communication device.
